(19) United States
(12) Patent Application Publication
(10) Pub. No.: US 2013/0072311 A1
(43) Pub. Date: Mar. 21, 2013

(54) Flexible Coupling Assembly for a Vehicle Drivetrain

(71) Applicants: Mark Christopher Smith, Troy, MI (US); Lon C. Cooper, Royal Oak, MI (US); Christopher Keeney, Troy, MI (US)

(72) Inventors: Mark Christopher Smith, Troy, MI (US); Lon C. Cooper, Royal Oak, MI (US); Christopher Keeney, Troy, MI (US)

(73) Assignee: ARVINMERITOR TECHNOLOGY, LLC, Troy, MI (US)

(21) Appl. No.: 13/235,687

(22) Filed: Sep. 19, 2011

(51) Int. Cl. F16D 3/12; F16D 3/79; F16D 3/78

(52) U.S. Cl. 464/99

(57) ABSTRACT

A flexible coupling assembly that may be provided with a vehicle drivetrain. The flexible coupling assembly may include a spacer ring, a first flexplate assembly, and a second flexplate assembly. The first and second flexplate assemblies may be spaced apart and fixedly disposed on the spacer ring. The first and second flexplate assemblies may be configured to independently flex.

### TECHNICAL FIELD

The present application relates to a flexible coupling assembly.

### BACKGROUND

A flexible coupling for a vehicle drivetrain is disclosed in U.S. Pat. No. 6,193,611.

### SUMMARY

In at least one embodiment, a flexible coupling assembly is provided. The flexible coupling assembly may include a spacer ring, a first flexplate assembly, and a second flexplate assembly. The first and second flexplate assemblies may be fixedly disposed on the spacer ring near an outside diameter and may be configured to be fixedly disposed on different drivetrain components near an inside diameter. The first and second flexplate assemblies may be spaced apart from each other and configured to independently flex.

In at least one embodiment, a flexible coupling assembly for a vehicle drivetrain is provided. The flexible coupling assembly may include a flywheel, a spacer ring, and first and second flexplate assemblies. The spacer ring may be spaced apart from the flywheel. The first flexplate assembly may engage the flywheel and the spacer ring. The second flexplate assembly may engage the spacer ring and may be spaced apart from the first flexplate assembly. The first and second flexplate assemblies may be configured to flex along an axis of rotation.

In at least one embodiment, a flexible coupling assembly for a vehicle drivetrain is provided. The flexible coupling assembly may include a flywheel and a flexplate module. The flywheel may be configured to be rotated about an axis of rotation. The flexplate module may be configured to receive a generator spindle. The flexplate module may include a spacer ring and first and second flexplate assemblies. The spacer ring may be spaced apart from the flywheel. The first and second flexplate assemblies may have first and second sets of mounting holes disposed at first and second radial distances from the axis of rotation. The first and second sets of mounting holes on the first flexplate assembly may receive fasteners that couple the first flexplate assembly to the flywheel and spacer ring, respectively. The first and second sets of mounting holes on the second flexplate assembly may receive fasteners that couple the second flexplate assembly to the generator spindle and spacer ring, respectively.

### BRIEF DESCRIPTION OF THE DRAWINGS

FIG. 1 is an exploded view of a portion of an exemplary vehicle drivetrain.

FIG. 2 is a side section view of a portion of the drivetrain.

FIG. 3 is a side view of a coupling assembly in an unflexed condition.

FIG. 4 is a side view of a coupling assembly in an exemplary flexed condition.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

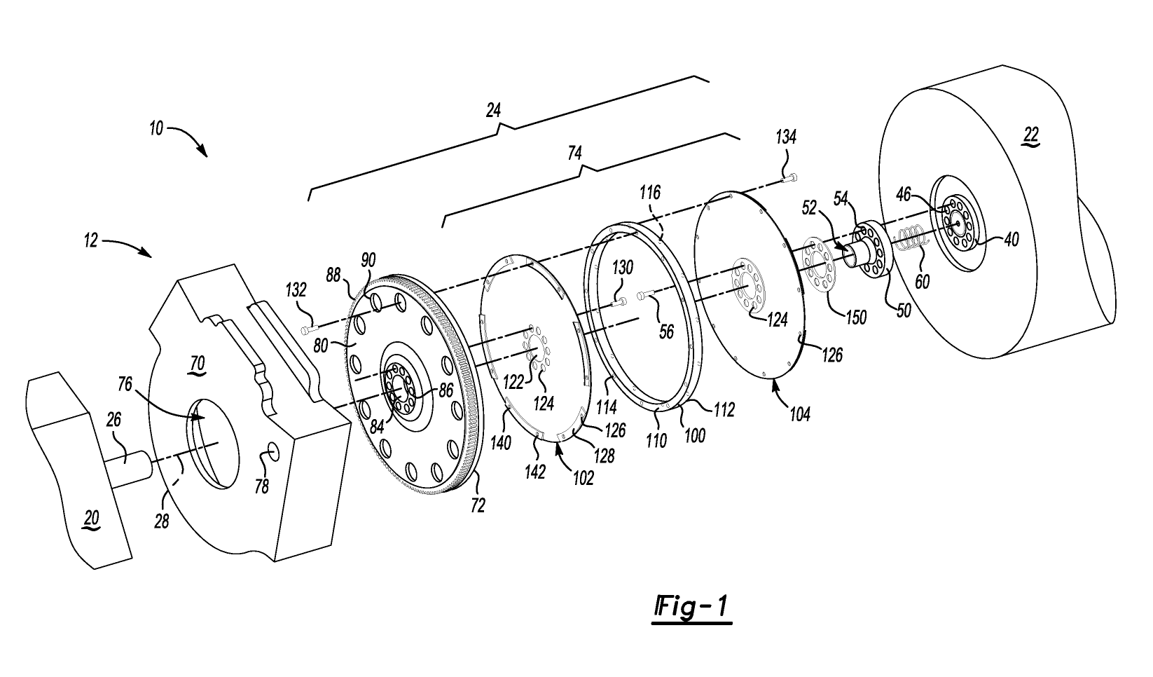

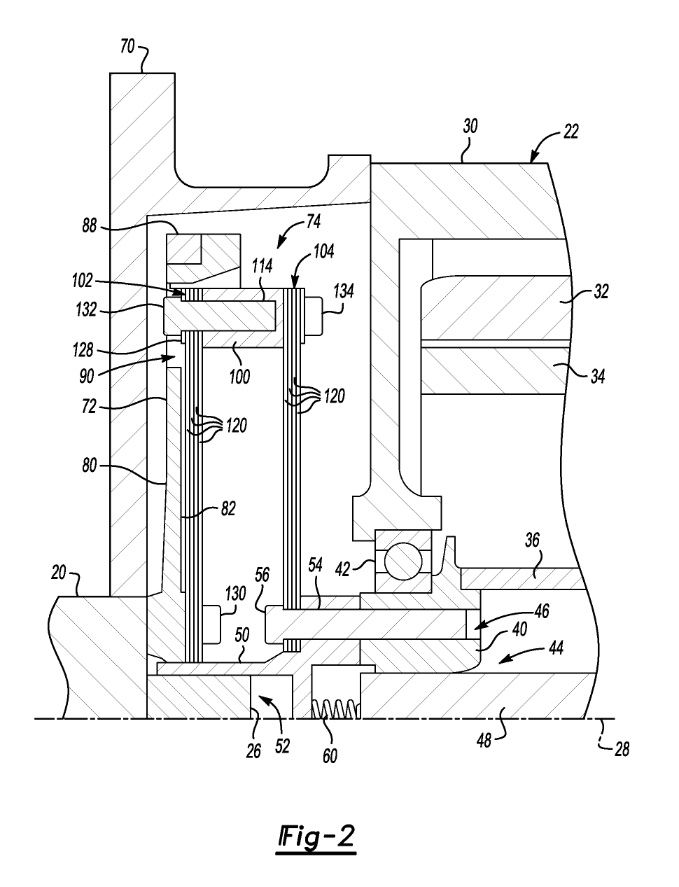

Referring to FIGS. 1 and 2, a portion of a vehicle 10 is shown. In at least one embodiment, the vehicle 10 may be a motor vehicle, such as a truck, bus, or automobile. The vehicle 10 may be configured as a hybrid vehicle that may have a plurality of power sources that may be used to propel the vehicle 10. As such, the vehicle 10 may have a hybrid drivetrain 12 that may include a first power source 20, a second power source 22, and a coupling assembly 24.

The first power source 20 may provide power that may be used to rotate one or more vehicle traction wheels. In at least one embodiment, the first power source 20 may be configured as an internal combustion engine that may be adapted to combust any suitable type of fuel, such as gasoline, diesel fuel, or hydrogen. Additionally, the first power source 20 may be an electrical power source. The first power source 20 may include an output shaft 26 that may be coupled to the second power source 22 via the coupling assembly 24 as will be discussed in more detail below. The output shaft 26 may rotate about an axis of rotation 28.

The second power source 22 may also be configured to rotate one or more vehicle traction wheels. In at least one embodiment, the second power source 22 may be configured as an electrical power source, such as a generator or motor generator. The second power source 22 may include a housing 30, a stator 32 that may be fixedly positioned in the housing 30, and a rotor 34 that may rotate with respect to the stator 32. These features are best shown in FIG. 2, which is a side section view along one side of the axis of rotation 28. This view may be mirrored with respect to the axis of rotation 28 to show a complete section view.

The rotor 34 may have a rotor shaft 36 that may be coaxially disposed with the axis of rotation 28. The rotor shaft 36 may have a first end and a second end disposed opposite the first end. The second end of the rotor shaft 36 may be fixedly coupled to a mounting member 40. For example, the rotor shaft 36 may be welded to the mounting member 40 in one or more embodiments. The mounting member 40 may engage a bearing assembly 42 that is disposed on the housing 30 that may facilitate rotation of the mounting member 40 about the axis of rotation 28. The mounting member 40 may include a center hole 44 and a set of fastener holes 46.

The center hole 44 may be coaxially disposed with the axis of rotation 28. The center hole 44 may receive a main shaft 48 of the second power source 22. In at least one embodiment, the center hole 44 may be at least partially defined by a splined surface that mates with a splined portion of the main shaft 48.

The set of fastener holes 46 may be disposed at a common radial distance from the axis 28 as is best illustrated in FIG. 1. The fastener holes 46 may be spaced apart from each other and may be substantially equidistantly spaced from an adjacent fastener hole 46. Each fastener hole 46 may extend substantially parallel to the axis of rotation 28.

A spindle 50 may engage and be fixedly disposed on the mounting member 40. The spindle 50 may also include a center hole 52 and a set of fastener holes 54. The center hole 52 may receive a portion of the output shaft 26. The set of fastener holes 54 may be aligned with and have a similar configuration as the fastener holes 46 on the mounting member 40. A fastener 56, such as a bolt, may extend through each fastener hole 54 on the spindle 50 and engage a corresponding fastener hole 46 on the mounting member 40 to fixedly couple the spindle 50 to the mounting member 40. The fastener 56 may also facilitate coupling of the coupling assembly 24 to the second power source 22 as will be discussed in more detail below.

A preload spring 60 may be disposed along the axis of rotation 28 between the spindle 50 and the main shaft 48. The preload spring 60 may exert a biasing force against the main shaft 48 that biases the main shaft 48 away from the spindle 50.

The coupling assembly 24 may couple the first power source 20 to the second power source 22. In addition, the coupling assembly 24 may be configured to accommodate movement or thermal expansion of components of a power source 20, 22. For example, components associated with the second power source 22 such as the rotor shaft 36, mounting member 40, and/or main shaft 48, may undergo thermal expansion due to heat generated during operation of the second power source 22. In at least one embodiment, the coupling assembly 24 may include a housing 70, a flywheel 72, and a flexplate module 74.

The housing 70 may at least partially define a cavity that receives the flywheel 72 and the flexplate module 74. The housing 70 may be spaced apart from the flywheel 72 and the flexplate module 74 to permit the flywheel 72 and flexplate module 74 to rotate about the axis of rotation 28. The housing 70 may include an opening 76 into which the output shaft 26 of the first power source 20 may extend. The housing 70 may be fixedly disposed on the first and/or second power sources 20, 22 in any suitable manner. For example, the housing 70 may be coupled to the first power source 20 and the housing 30 of the second power source 22 with one or more interlocking mating features or fasteners, such as a bolt or pin. In addition, the housing 70 may include a housing access hole 78 that facilitates installation of fasteners through the flywheel 72 to assemble the flexplate module 74.

The flywheel 72 may be disposed on the spindle 50 and may be configured to rotate about the axis of rotation 28. The flywheel 72 may be generally disk shaped and may include a first surface 80, a second surface 82, a spindle opening 84, a set of flexplate mounting holes 86, a ring gear 88, and a plurality of access holes 90.

The first surface 80 may be spaced apart from and disposed opposite the second surface 82. The first surface 80 may face toward the first power source 20 while the second surface 82 may face toward the second power source 22.

The spindle opening 84 may extend through the center of the flywheel 72 and may be centered about the axis 28. The spindle opening 84 may receive the spindle 50 such that spindle 50 engages the flywheel 72 in the spindle opening 84.

The set of flexplate mounting holes 86 may facilitate mounting of the flexplate module 74 to the flywheel 72 as will be discussed in more detail below. The flexplate mounting holes 86 may extend from the second surface 82 toward or to the first surface 80. The flexplate mounting holes 86 may be spaced apart from and disposed around the spindle opening 84. Moreover, the flexplate mounting holes 86 may be spaced apart from each other and be disposed at a common radial distance from the axis 28.

The ring gear 88 may be disposed along an outside diameter of the flywheel 72. The ring gear 88 may extend from the first surface 80 toward the second surface 82 and may include a plurality of teeth. The teeth may engage a corresponding gear on a starter motor that may be used to rotate and initiate operation of a first power source 20 when configured as an internal combustion engine.

The access holes 90 may extend through the flywheel 72 to facilitate assembly of the coupling assembly 24. The access holes 90 may be radially disposed between the flexplate mounting holes 86 and the ring gear 88. The access holes 90 may be spaced apart from each other and may be disposed at a common radial distance from the axis 28.

The flexplate module 74 may flexibly couple the first power source 20 to the second power source 22. The flexplate module 74 may include a spacer ring 100, a first flexplate assembly 102, and a second flexplate assembly 104.

The spacer ring 100 may be configured as a generally circular ring that at least partially defines an internal cavity. The spacer ring 100 may be disposed around and spaced apart from the axis 28. The spacer ring 100 may include a first surface 110 and a second surface 112 that may be spaced apart from and disposed opposite the first surface 110. In at least one embodiment, the first and second surfaces 110, 112 may be generally planar and may extend substantially parallel to each other. The first surface 110 may include a first set of mounting holes 114. The second surface 112 may include a second set of mounting holes 116.

The first set of mounting holes 114 may extend from the first surface 110 toward or to the second surface 112. In addition, the first set of mounting holes 114 may be disposed at a common radial distance from the axis 28. The members of the first set of mounting holes 114 may be equidistantly spaced apart from each other. In addition, each mounting hole 114 may include threads that may mate with threads on an associated fastener.

The second set of mounting holes 116 may extend from the second surface 112 toward or to the first surface 110. The second set of mounting holes 116 may also be disposed at a common radial distance from the axis 28. This radial distance may be the same as that for the first set of mounting holes 114. Moreover, the second set of mounting holes 116 may be offset from and/or not disposed directly opposite a member of the first set of mounting holes 114. As such, members of the second set of mounting holes 116 may be spaced apart from the members of the first set of mounting holes 114. The second set of mounting holes 116 may have a similar configuration as members of the first set of mounting holes 114. For instance, members of the second set of mounting holes 116 may be equidistantly spaced apart from each other and may include threads that may mate with threads on an associated fastener.

The first and second flexplate assemblies 102, 104 may be spaced apart from each other and may be configured to flexibly couple the first and power sources 20, 22 via the spacer ring 100. The first and second flexplate assemblies 102, 104 may include a set of flexplates 120. In the embodiment shown, four flexplates 120 are provided; however a different number of flexplates 120 may be employed in other embodiments. Each of the flexplates 120 may be made from a thin sheet of material, such as a metal alloy, and may have similar or identical configurations. In at least one embodiment, a flexplate 120 may be generally circular or disk shaped and may include a center hole 122, a first set of mounting holes 124, a second set of mounting holes 126, and a set of reinforcement members 128.

The center hole 122 may extend through the center of each flexplate 120 and may be centered about the axis 28. The center hole 122 may receive the spindle 50. In at least one embodiment, the spindle 50 may engage a portion of one or more flexplates 120 proximate the center hole 122. In one or more embodiments, a spline may be provided with the center hole 122 of a flexplate assembly 102, 104 to facilitate mounting to a corresponding spline on the output shaft 26 and/or spindle 50. In such an embodiment, the first set of mounting holes 124 and associated fasteners may be omitted.

Each member of the first set of mounting holes 124 may be disposed at a common radial distance from the axis 28. In addition, each member of the first set of mounting holes 124 may be spaced apart from each other and may be substantially equidistantly spaced from an adjacent mounting hole 124. The first set of mounting holes 124 may be aligned on each flexplate 120 such that through holes are created that may receive a fastener, such as bolt, that facilitates mounting of a flexplate assembly 102, 104 to another component. For instance, the first set of mounting holes 124 on the first flexplate assembly 102 may each receive a fastener 130 that engages a corresponding flexplate mounting hole 86 on the flywheel 72. The first set of mounting holes 124 on the second flexplate assembly 104 may each receive a fastener 56 that engages or is received in a corresponding fastener hole 54 of the spindle 50 and may engage a corresponding fastener hole 46 on the mounting member 40. As such, an inside diameter region of the first flexplate assembly 102 may be fixedly coupled to the flywheel 72 while an inside diameter region of the second flexplate assembly 104 may be fixedly coupled to the spindle 50 and/or the mounting member 40.

The second set of mounting holes 126 may be disposed at a common radial distance from the axis 28. This radial distance from the axis 28 may be greater than the radial distance at which the first set of mounting holes 124 is disposed from the center axis 28. Each member of the second set of mounting holes 126 may be spaced apart from each other and may be substantially equidistantly spaced from an adjacent mounting hole 126.

The second set of mounting holes 126 may be aligned on each flexplate 120 such that through holes are created that may receive a fastener that facilitates mounting of a flexplate assembly 102, 104 to another component. For instance, the second set of mounting holes 126 on the first flexplate assembly 102 may be aligned with a corresponding member of the first set of mounting holes 114 disposed on the first surface 110 of the spacer ring 100. These aligned holes may each receive a fastener 132, such as a bolt, for coupling the first flexplate assembly 102 to the spacer ring 100. The fastener 132 may be inserted through a member of the set of access holes 90 disposed in the flywheel 72. The second set of mounting holes 126 on the second flexplate assembly 104 may be aligned with a corresponding member of the second set of mounting holes 116 disposed on the second surface 112 of the spacer ring 100. These aligned holes may each receive a fastener 134, such as a bolt, for coupling the second flexplate assembly 102 to the spacer ring 100.

A member of the set of reinforcement members 128 may be disposed along an external surface of each flexplate assembly 102, 104. In at least one embodiment, each reinforcement member 128 may be spaced apart from each other. In addition, each reinforcement member 128 may extend along an arc and may be disposed proximate the outside diameter of a flexplate assembly 102, 104. In the embodiment shown, each reinforcement member 128 may include a first hole 140 and a second hole 142. The first and second holes 140, 142 may be spaced apart from each other and may be aligned with a corresponding member of the second set of mounting holes 126. As such, the reinforcement member 128 may be disposed between the head of a fastener and the outermost flexplate 120 of a flexplate assembly 102, 104. For instance, a reinforcement member 128 on the first flexplate assembly 102 may be disposed between the fastener 132 and the flexplate 120 that faces toward the first power source 20. A reinforcement member 128 on the second flexplate assembly 104 may be disposed between the fastener 134 and the flexplate 120 that faces toward the second power source 22. As such, an outside diameter region of each flexplate assembly 102, 104 may be fixedly coupled to the spacer ring 110.

In one or more embodiments, a wear plate 150 may be provided between the second flexplate assembly 104 and the spindle 50.

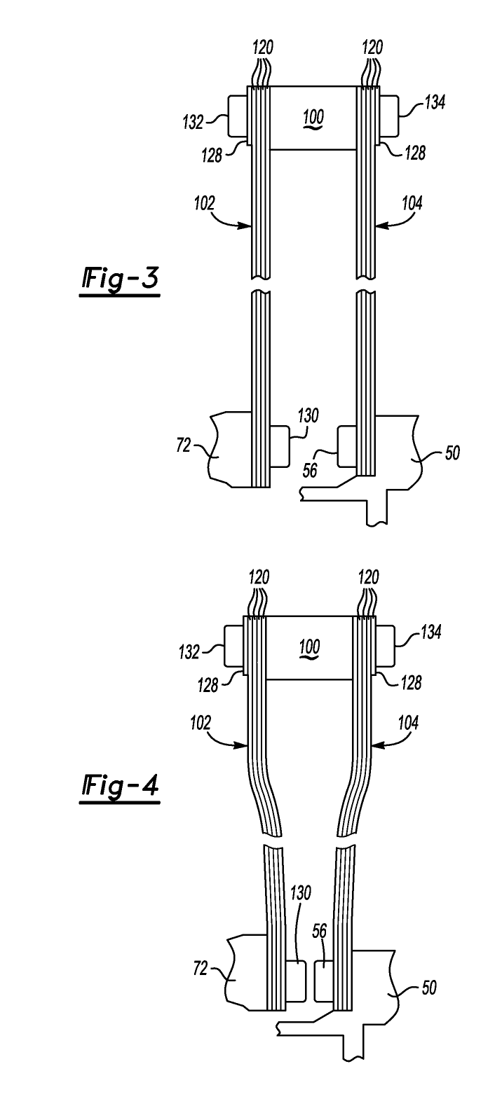

Referring to FIGS. 3 and 4, the flexplate assemblies 102, 104 may be configured to independently flex, bend, or move with respect to each other. More specifically, the flexplates 120 of each flexplate assembly 102, 104 may be configured to flex, bend, or move with respect to an adjacent flexplate 120. For example, each flexplate 120 may engage at least one adjacent flexplate 120 but may not be adhered or welded together. Instead, the flexplates 120 may be clamped together proximate their inside and outside diameters by the fasteners that extend through the first and second sets of mounting holes 124, 126 as described above. As such, each flexplate 120 may be configured to flex or slide with respect to an adjacent flexplate 120 in the region disposed between the first and second sets of mounting holes 124, 126. The first flexplate assembly 102 may be spaced apart from the flywheel 72 to accommodate flexural movement of the first flexplate assembly 102. Similarly, the second flexplate assembly 104 may be spaced apart from the housing 30 of the second power source 22 to accommodate flexural movement of the second flexplate assembly 104.

An example of flexural movement is illustrated by comparing in FIG. 3 with FIG. 4. In FIG. 3, the flexplate assemblies 102, 104 are shown in an unflexed position in which the flexplates 120 are in a generally planar configuration. In FIG. 4, the flexplate assemblies 102, 104 are shown in an exemplary flexed condition in which the flexplates 120 are not generally planar. In FIG. 4, the flexplates 102, 104 are shown closer together near the axis 28 than near the spacer ring 100. The flexplates 102, 104 may flex by the same or different distances on opposite sides of the axis 28. For example, the flexplate assemblies 102, 104 may flex such that the flexplate assemblies 102, 104 tilt or are closer together along one side of the axis 28 than the opposite side. In another example, the flexplate assemblies 102, 104 may move toward or away from each other along the axis 28 by substantially the same amount or symmetrically with respect to opposite sides of the axis 28. As such, each flexplate assembly 102, 104 may flex to accommodate thermal expansion of components associated with the first and/or second power sources, 20, 22, respectively, while coupling the power sources 102, 104 together and accommodating rotational movement about the axis 28.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A flexible coupling assembly comprising:
a spacer ring;
a first flexplate assembly that is fixedly disposed on the spacer ring near an outside diameter and configured to be fixedly disposed on a first drivetrain component near an inside diameter; and
a second flexplate assembly that is spaced apart from the first flexplate assembly and fixedly disposed on the spacer ring near an outside diameter and configured to be fixedly disposed on a second drivetrain component near an inside diameter;
wherein the first and second flexplate assemblies are configured to independently flex.

2. The flexible coupling assembly of claim 1 wherein the spacer ring includes a first surface and a second surface disposed opposite the first surface, wherein the first flexplate assembly engages the first surface and the second flexplate assembly engages the second surface.

3. The flexible coupling assembly of claim 1 wherein the first drivetrain component is a flywheel.

4. The flexible coupling assembly of claim 1 wherein the second drivetrain component is a generator.

5. The flexible coupling assembly of claim 1 wherein the second drivetrain component is a spindle that extends through a center hole of the first and second flexplate assemblies.

6. The flexible coupling assembly of claim 1 wherein the first flexplate assembly includes a set of flexplates having substantially similar configurations, wherein each member of the set of flexplates engages at least one other member of the set of flexplates.

7. The flexible coupling assembly of claim 6 wherein the members of the set of flexplates are not fixedly mounted to another member of the set along at least a portion of a region disposed between the inside and outside diameters.

8. A flexible coupling assembly for a vehicle drivetrain, comprising:
a flywheel configured to rotate about an axis of rotation;
a spacer ring that is spaced apart from the flywheel;
a first flexplate assembly that engages the flywheel and the spacer ring; and
a second flexplate assembly that engages the spacer ring and is spaced apart from the first flexplate assembly;
wherein the first and second flexplate assemblies are configured to flex along the axis of rotation.

9. The flexible coupling assembly of claim 8 wherein the second flexplate assembly is configured to engage a spindle disposed on a generator.

10. The flexible coupling assembly of claim 9 wherein the flywheel is disposed on the spindle.

11. The flexible coupling assembly of claim 8 wherein the first flexplate assembly includes a first set of mounting holes disposed at a first radial distance from the axis of rotation, and a second set of mounting holes disposed a second radial distance from the axis of rotation, wherein the first radial distance is less than the second radial distance.

12. The flexible coupling assembly of claim 11 wherein each member of the first set of mounting holes receives a fastener that engages a corresponding mounting hole in the flywheel.

13. The flexible coupling assembly of claim 11 wherein each member of the second set of mounting holes receives a fastener that engages a corresponding mounting hole in the spacer ring.

14. The flexible coupling assembly of claim 8 wherein the second flexplate assembly includes a first set of mounting holes disposed at a first radial distance from the axis of rotation, and a second set of mounting holes disposed a second radial distance from the axis of rotation, wherein the first radial distance is less than the second radial distance.

15. The flexible coupling assembly of claim 14 wherein each member of the first set of mounting holes receives a fastener that is configured to engage a corresponding mounting hole in a spindle that engages the flywheel.

16. The flexible coupling assembly of claim 14 wherein each member of the second set of mounting holes receives a fastener that engages a corresponding mounting hole in the spacer ring.

17. A flexible coupling assembly for a vehicle drivetrain, comprising:
a flywheel configured to be rotated about an axis of rotation;
a flexplate module configured to receive a generator spindle, wherein the flexplate module includes:
a spacer ring that is spaced apart from the flywheel; and
first and second flexplate assemblies having first and second sets of mounting holes disposed at first and second radial distances from the axis of rotation, respectively;
wherein the first and second sets of mounting holes on the first flexplate assembly receive fasteners that couple the first flexplate assembly to the flywheel and spacer ring, respectively; and
wherein the first and second sets of mounting holes on the second flexplate assembly receive fasteners that couple the second flexplate assembly to the generator spindle and spacer ring, respectively.

18. The flexible coupling assembly of claim 17 wherein the first and second flexplate assemblies each include a plurality of substantially similar flexplates that flex between the first and second radial distances.

19. The flexible coupling assembly of claim 17 wherein the first flexplate assembly includes a set of reinforcement members disposed on an exterior surface, wherein each reinforcement member is spaced apart from other members of the set of reinforcement members and each reinforcement member includes first and second holes that align with corresponding members of the second set of mounting holes of the first flexplate assembly.

20. The flexible coupling assembly of claim 19 wherein the flywheel include a plurality of access holes disposed between the first and second sets of mounting holes.
